(19) United States
(12) Patent Application Publication
(10) Pub. No.: US 2026/0111179 A1
(43) Pub. Date: Apr. 23, 2026

(54) SYSTEMS AND METHODS FOR CODE SEARCH USING NEURAL NETWORK BASED LANGUAGE MODELS

(71) Applicant: Salesforce, Inc., San Francisco, CA (US)

(72) Inventors: Jierui Li, Austin, TX (US); Hung Le, Singapore (SG); Doyen Sahoo, Singapore (SG)

(21) Appl. No.: 19/231,197

(22) Filed: Jun. 6, 2025

Related U.S. Application Data
(60) Provisional application No. 63/708,945, filed on Oct. 18, 2024.

(51) Int. Cl. G06F 8/33; G06F 8/71

(52) U.S. Cl. CPC G06F 8/33; G06F 8/71

(57) ABSTRACT

Embodiments described herein provide a code generation framework that explores a code search space of code generation tasks through a tree-based structure. Specifically, the code generation framework comprises a Thinker model, a Solver model, and a Debugger model to implement strategy-planning, solution implementation, and solution improving correspondingly. posing comprehensive roles needed for code generation.

### CROSS REFERENCE(S)

The application is a nonprovisional of and claims priority to co-pending and commonly-owned U.S. provisional application No. 63/708,945, filed Oct. 18, 2024, which is hereby incorporated by reference herein in its entirety.

### TECHNICAL FIELD

The embodiments relate generally to machine learning systems for conducting searches, and more specifically to using neural network language models for code search.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

In some applications, AI agents have been employed to generate code programs in response to a natural language description. Different from traditional NLP tasks, coding tasks demand generated code to be fully executable and functionally correct, i.e. containing no programmatic syntax errors and passing all possible test cases. Given the extremely large search space in code programs, existing approaches may sample a very large number of generation outputs, e.g., even up to 10,000 samples per input descriptions, to increase the chance of generating a correct code solution. However, selecting the correct code program from the large number of sampled outputs can be computationally efficient. Alternatively, an LLM may first generate one (or very few) generation output of code program, and then iteratively refine this output code program multiple times, often conditioned by some forms of external feedback such as execution results. The fixed pipeline of generation, testing and debugging still leads to a computationally expensive process to arrive at a final code output.

### BRIEF DESCRIPTION OF THE DRAWINGS

FIG. 1 shows an example operation of an LLM based AI coding generation agent handling a user request to generate a code solution to solve a target problem, according to embodiments of the present disclosure.

FIG. 2 is a simplified diagram illustrating a code generation framework involving multiple LLM agents to iteratively plan, generate and debug a code program, according to some embodiments.

FIG. 3 is a simplified diagram illustrating aspects of flexibly navigating a code tree structure for code generation employing the multiple LLM agents described in FIG. 2, according to embodiments described.

FIG. 4 is a simplified diagram illustrating a computing device implementing the code generation framework described in FIGS. 1-3, according to some embodiments.

FIG. 5 is a simplified diagram illustrating a neural network structure, according to some embodiments.

FIG. 6 is a simplified block diagram of a networked system suitable for implementing the code generation framework described in FIGS. 1-5 and other embodiments described herein.

FIGS. 7A-7B provide an example logic flow diagram illustrating a method of AI agentic code generation based on a natural language description based on the framework shown in FIGS. 1-6, according to some embodiments described herein.

FIG. 8 provides example performance charts of the AI coding generation agent of different coding problems, according to embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

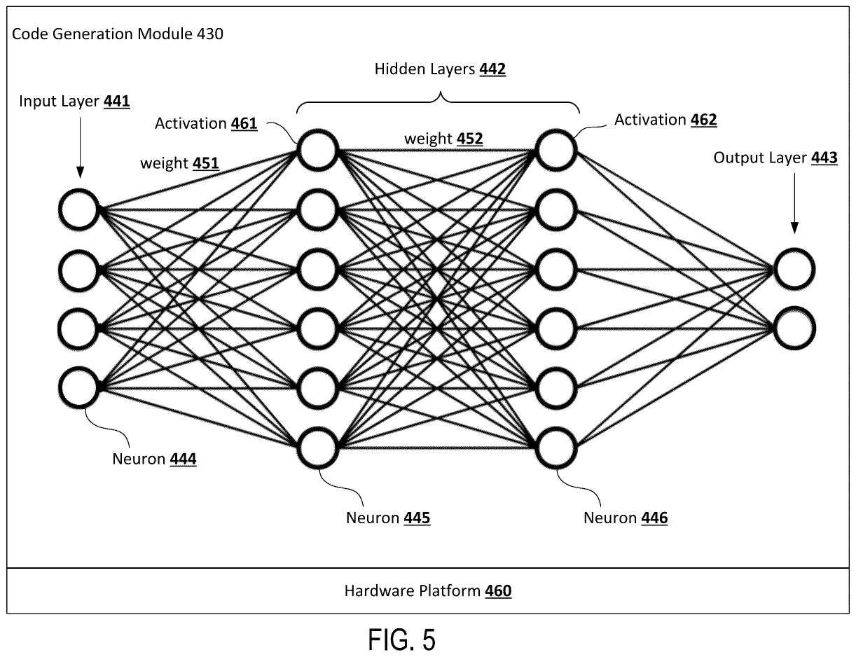

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 5.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Traditional LLMs may search for a code program in response to a natural language description by sampling a very large number of code programs from a large code space based on generated outputs. Such methods can be rather computationally inefficient. Alternatively, an LLM may first generate one (or very few) generation output of code program, and then iteratively refine this output code program multiple times, often conditioned by some forms of external feedback such as execution results. The fixed pipeline of generation, testing and debugging still leads to a computationally expensive process to arrive at a final code output.

In view of the need for efficient and accurate code generation systems, embodiments described herein provide a code generation framework that explores a code search space of code generation tasks through a tree-based structure. Specifically, the code generation framework comprises a Thinker model, a Solver model, and a Debugger model to flexibly implement strategy-planning, solution implementation, and solution improving correspondingly to iteratively arrive at a final code output. For example, given a text problem description, the Thinker model may generate multiple strategies, along each of which the Solver model may generate a code solution and the Debugger model may subsequently improve the code solution. The generative process may be guided by a critic model, which decides, from each currently generated code program, whether to abort the generation from the currently version of the code program but re-start at a different strategy, to accept the current version of code program as the final output, or to further debug and refine the current version of core program. A code tree structure can thus be formulated to allow generation of different versions of code solutions to improve generation efficiency.

In one embodiment, a method for performing code generation in response to a natural language query comprises constructing and navigating a hierarchical code tree data structure. The code tree is initialized at a root node representing the initial search context or problem specification derived from the query. From the root node, each subsequent node in the tree corresponds to a candidate code generation strategy or partial solution refinement. Tree traversal involves two principal navigation actions: (1) lateral exploration of sibling nodes that represent alternative solution strategies derived from the same parent context, and (2) downward expansion into child nodes that represent refinements or extensions of a specific code generation trajectory.

In one embodiment, navigation and expansion of the code tree structure are governed by the critic model configured to dynamically evaluate and manage tree growth and code search along the code tree. Unlike traditional rule-based or heuristic tree traversal algorithms, the critic model operates using a self-evaluation mechanism comprising two core procedures at each node expansion step: (i) node scoring, which involves executing the candidate code associated with a tree node against a predefined set of test cases to compute a fidelity score that quantifies adherence to the intended coding strategy and correctness of output; and (ii) solution verification and evaluation, which determines whether a generated solution that passes visible (public) test cases is likely to generalize to hidden (unseen) test cases. This includes using the critic model to determine whether a passing solution requires further refinement or whether a failing solution merits continued debugging based on its deviation from expected behavior.

Based on the outcomes of these evaluations, the critic model can autonomously select from a set of discrete actions including: (a) initiating child node expansions to refine the current solution, (b) terminating exploration along unpromising branches, or (c) designating a node as a final candidate solution. This guided expansion mechanism enables the code tree framework to optimize search efficiency by minimizing redundant or functionally equivalent solution paths, thus facilitating scalable and high-precision code generation. Therefore, code generation using the code tree structure provides a flexible and efficient solution, avoiding duplicated or redundant exploration paths over functionally similar or unfeasible solutions. Automatic code generation technology is thus improved.

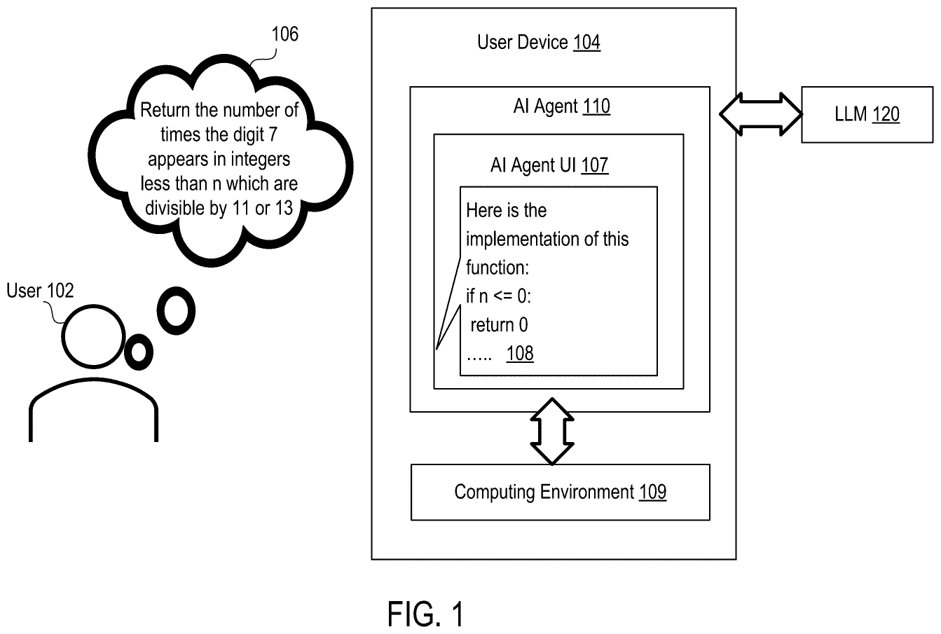

FIG. 1 shows an example operation of an LLM based AI coding generation agent handling a user request to generate a code solution to solve a target problem, according to embodiments of the present disclosure. An LLM-based AI agent 110 may be implemented on a user device 104 interacting with the computing environment 109 to receive a user task request 106 as a natural language input, typically through a chat or command interface 107. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.”

It is to be noted that one LLM 120 is shown in FIG. 1 for illustrative purpose only. In some embodiments, multiple LLM(s) 120 deployed on different hardware platforms, such as distributed servers, may be communicatively coupled to support the AI agent 110.

In one embodiment, the LLM 120 may comprise one or more smaller LLMs, or may be guided by different system prompts to in turn generate a response 108 to the task request 106. Additional details on the LLM 120 generating output tokens to form the response 108 may be described in FIG. 5.

In some embodiments, the request 106 may comprise a natural language description of a target problem that needs to be solved by a code program, e.g., to generate “the number of times the digit 7 appears in integers less than n which are divisible by 11 or 13.” The AI agent 110 processes the task request 106 at an LLM 120, extracts key information such as the task type, desired outcome, and any specific constraints, based on which to use the right system prompt to generate a response, in the form of a code program 108. The code program 108 may then be tested and/or debugged to verify whether it is executable in a coding environment; and if executable, whether it produces the correct solution to the target problem.

Specifically, a code generation task in response to user input 106 may be processed as a sequence-to-sequence task. The input sequence to LLM 120 consists of a problem description D 106, usually in the form of a function docstring (including expected input and output) or the textual explanation of the problem. The LLM output is a corresponding code solution, flattened into a sequence of tokens Ŵ=(ŵ₁, . . . , ŵ_{T}) with ŵₜϵV. Before outputting to the AI agent user interface 107, generated codes are evaluated against hidden test cases to check the functional correctness. The test cases are a set of input-output pairs {(iⱼ, Oⱼ)}={(iⱼ, Oⱼ)v} U {(iⱼ, Oⱼ)ₕ}. Visible test cases are denoted as {(iⱼ, oj-)ᵥ} while hidden test cases are denoted as {(ij, Oⱼ)ₕ}. An output code Wis correct when W(iⱼ)=oⱼ Vⱼ. The output code that pass all test cases may be output at the AI agent UI 107.

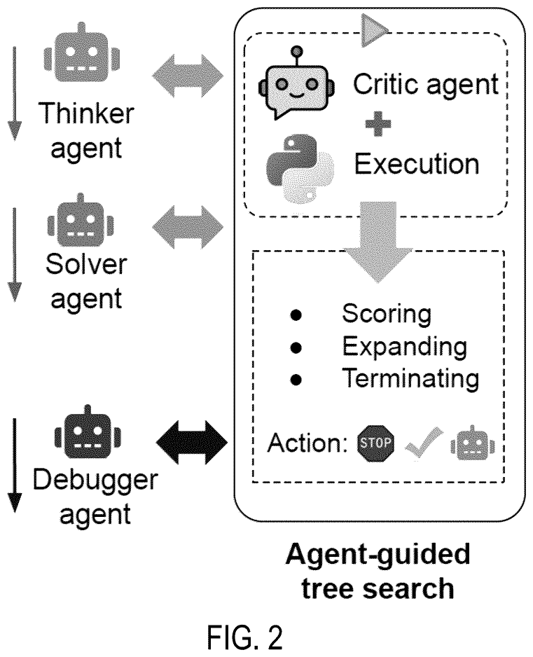

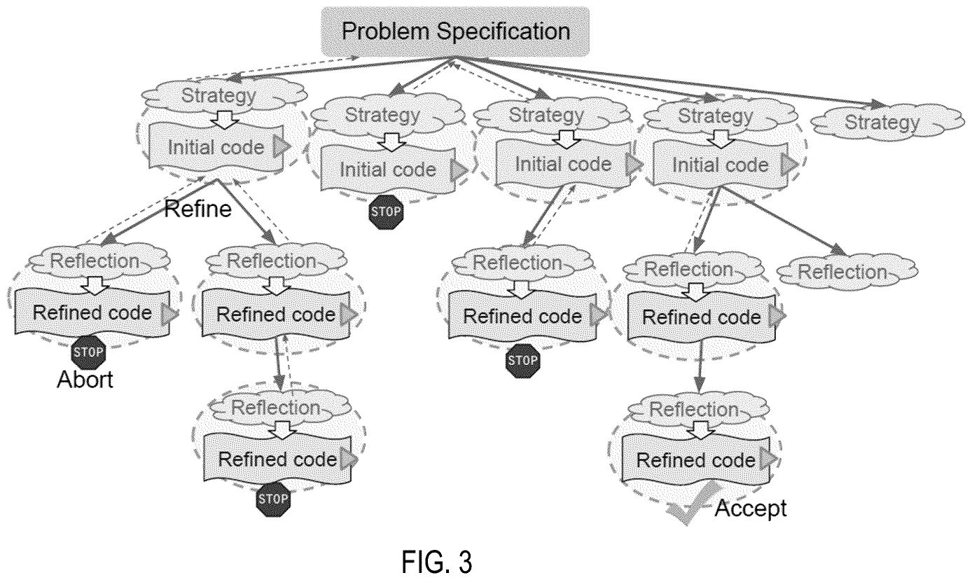

Therefore, instead of using the LLM 120 to generate the code output 108 in a once-and-for-all manner, the LLM 120 may serve, guided by different system prompts, as different agents to flexibly plan, generate, test, and debug a code program to iteratively generate a final code solution 108. The different types of agents and the iterative generation process are described below in FIGS. 2-3.

FIG. 2 is a simplified diagram illustrating a code generation framework involving multiple LLM agents to iteratively plan, generate and debug a code program, according to some embodiments. In one embodiment, the code generation framework creates a unified search space for exploration throughout the multi-stage code generation process: strategy generation by a “Thinker” agent 202, initial code generation by a “Solver” agent 204, and code improvement by a “Debugger” agent 206. An additional critic Agent 212 may be employed to generate AI-generated feedback, based on which, together with environmental execution-based feedback, to decide the next step action 224.

In one embodiment, thinker agent 202, solver agent 204, debugger agent 206 and/or critic agent 212 may each be built on a specific LLM pretrained to undertake the respective tasks. In one embodiment, thinker agent 202, solver agent 204, debugger agent 206 and/or critic agent 212 may be built on the same foundation LLM (such as GPT-40) and act as a specific agent using the corresponding system prompt.

In one embodiment, the thinker agent 202 may generate one or more strategies (in natural language descriptions) in response to a problem specification (in natural language). For example, LLM θ_{T}, based on which the thinker agent 202 is built, is employed to generate a sequence of high-level coding strategies in response to a given input coding problem. The thinker agent 202 may operate in an autoregressive manner, where each strategy Ŝᵢ is generated conditioned on the input problem description and the sequence of previously generated strategies.

In one embodiment, the thinker agent 202 may generate strategies that explicitly represent multiple plausible problem-solving approaches in natural language before code generation is attempted. The thinker agent 202 is further configured to dynamically determine the number of strategies to output, based on the complexity and nature of the given problem instance. In this way, the thinker agent 202 may allow for the representation of varying levels of solution diversity across different problem types, which can influence downstream code generation and tree-based exploration.

For example, the LLM θ_{T} (e.g., LLM 120 in FIG. 1) may sequentially generate a set of high-level strategies given an input coding problem (e.g., 106 in FIG. 1). Each strategy Ŝᵢ is generated autoregressively given previously generated strategies following:

$${\hat{S}}_{i} \sim {p}_{{θ}_{T}} ( . \vert {\hat{S}}_{i - 1} , D ) \qquad ( 1 )$$

In this way, allowing LLM(s) to generate coding strategies enables large language models (LLMs) to address coding problems using reasoning capabilities learned from the text domain. The use of natural language to express these strategies can help guide the code generation process toward exploring a broader range of solution paths.

An example prompt for the thinker agent 202 to generate multiple strategies may take a form similar to:

<system>:
You are an AI assistant that provides strategy for Python programmers to code. You will be given a
function signature and its
docstring by the user. Your goal is to think of multiple distinct strategies in English(Not Code) on
how to approach this problem and
solve it. The number of alternatives should be determined for this specific problem.
-----------------------------------
Your answer should be formatted as below:
List and Number your strategies line by line using ″1. ″; ″2. ″; ″3. ″ and so on.
Describe each strategy with a FEW sentences in a SINGLE Line.
<user>:
[problem description]:
‘‘‘
def fizz_buzz(n: int):
″″″Return the number of times the digit 7 appears in integers less than n which are divisible by 11
or 13.
>>> fizz_buzz(50)
0
>>> fizz_buzz(78)
2
>>> fizz_buzz(79)
3
″″″
‘‘‘
<assistant>:
1. Start by understanding the problem requirements and constraints, focusing on the need to count
occurrences of the digit ′7′ in
specific integers.
2. Identify the range of integers to consider, which is from 0 to n−1, and clarify the conditions for
divisibility by 11 or 13.
3. Create a loop to iterate through all integers from 0 to n−1, checking each integer for divisibility by
11 or 13.
4. For each integer that meets the divisibility condition, convert it to a string to facilitate counting
occurrences of the digit ′7′.
5. Use the string method ‘.count(′7′)‘ to count how many times ′7′ appears in the string
representation of the integer.

Additionally, an example prompt for the thinker agent 202 to reflect on a generated code program and generate error reflections may take a form similar to:

<system>: You are a programming assistant. You goal is to help the user to correct their buggy code.
You will be given an incorrect
function implementation and a series of unit tests & execution results. There could be multiple
ways to fix the error, you should
provide reflection alternatives using various strategies. The number of reflection alternatives
depends on the situation(e.g., if you
are certain about where the bug is, you can provide only one). Each self-reflection should be
complete and self-contained. If there
are more than one bugs, they should be presented in one reflection rather than separately.
-----------------------------------
Your answer should be formatted as below:
List and Number your strategies line by line using “1. ”; “2. ”; “3. ” and so on.
Describe each strategy with a FEW sentences in a SINGLE Line.
<user>:
[problem]
[solution]
[execution results on visible test cases]
[agent feedback] if any

In one embodiment, the solver agent 204 may generate a code program (in programming language) based on a strategy description from the thinker agent 202. For example, given a complete generated strategy Ŝᵢ, the LLM θ_{S} for the solver agent 204 may generate a set of initial code solutions in a programming language. Since LLMs are often fine-tuned to follow arbitrary instructions in natural language, these models can understand novel unseen tasks during test time. Therefore, by including the strategy output from the thinker agent 202 as part of the input instruction, the solver agent 204 may be positioned to produce strategy-specific code candidates. For each candidate, the generation objective is defined as:

$${\hat{W}}_{i} \sim {p}_{{θ}_{s}} ( {\hat{S}}_{i} , D ) \qquad ( 2 )$$

An example prompt for the solver agent 204 to generate a code program may take a form similar to:

<system>:
You are an AI that only responds with python code, NOT ENGLISH. You will be given a function
signature and its docstring by the
user. Write your full implementation (restate the function signature). Don't include test cases or
printing statements in the code
block.
<user>:
‘‘‘
def fizz_buzz(n: int):
″″″Return the number of times the digit 7 appears in integers less than n which are divisible by 11
or 13.
>>> fizz_buzz(50)
0
>>> fizz_buzz(78)
2
>>> fizz_buzz(79)
3
″″″
‘‘‘
To solve the problem, You can follow the hint given by an expert: Start by understanding the
problem requirements and constraints,
focusing on the need to count occurrences of the digit ′7′ in specific integers.
<assistant>:
‘‘‘
def fizz_buzz(n: int):
″″″Return the number of times the digit 7 appears in integers less than n which are divisible by 11
or 13.
>>> fizz_buzz(50)
0
>>> fizz_buzz(78)
2
>>> fizz_buzz(79)
3
″″″
count = 0
for i in range(n):
if i % 11 == 0 or i % 13 == 0:
count += str(i).count(′7′)
return count

In one embodiment, the debugger agent 206 may generate a refined code program (in programming language) based on execution feedback and/or AI-generated feedback of the code program from the solver agent 204. For example, syntactic mistakes or even logical flaws in generated code may be fixed by allowing LLMs to iteratively refine and regenerate the code. This self-refinement capability is typically strengthened by some forms of feedback about the code qualities (e.g. execution results, compiler signals):

$${F}_{exe , i} = {W}_{i} ( \{ {( {i}_{j} , {o}_{j} )}_{v} \} ) \qquad ( 3 )$$

$${F}_{cri , i} = {θ}_{C} ( {\hat{W}}_{i} , {\hat{S}}_{i} , {F}_{exe , i} D ) \qquad ( 4 )$$

where θ_{C} is the LLM for the critic agent 212. Denoting the collective feedback as Fᵢ={F_{exe,i}, F_{cri,i}}, a set of reflections Rᵢ about the code candidates are generated by the thinker agent 202.

$${\hat{R}}_{i , j} \sim {p}_{{θ}_{T}} ( . \vert {\hat{R}}_{i , 1 : j - 1} , {F}_{i} , {\hat{W}}_{i} , {\hat{S}}_{i} , D ) \qquad ( 5 )$$

$${\hat{W}}_{i , j} \sim {p}_{{θ}_{D}} ( . \vert {\hat{R}}_{i , j} , {F}_{i} , {\hat{W}}_{i} , {\hat{S}}_{i} , D ) \qquad ( 6 )$$

\hat{R}_{i,j} denotes the jth reflection that “Thinker” generates for Ŵᵢ. An LLM θ_{D} (“Debugger” Agent) will modify Ŵᵢ, referring this reflection, generating a new program correspondingly.

An example prompt for the debugger agent 206 to generate a code program may take a form similar to:

<system>:
You are an AI Python assistant. You will be given a program implementation to improve, a series of
unit tests and execution
feedback, and a hint to change the implementation appropriately. Write your full implementation
(restate the function signature).
<user>:
[Implementation to Improve]:
‘‘‘
def fizz_buzz(n: int):
″″″Return the number of times the digit 7 appears in integers less than n which are divisible by 11
or 13.
>>> fizz_buzz(50)
0
>>> fizz_buzz(78)
2
>>> fizz_buzz(79)
3
″″″
# Start by understanding the problem requirements and constraints, focusing on the need to count
occurrences of
the digit ′7′ in specific integers.
count = 0
for i in range(n):
if i % 11 == 0 or i % 13 == 0:
count += str(i).count(′7′)
return count
‘‘‘
[Execution Feedback on Visible Test Cases]:
Tested passed:
‘‘‘
assert fizz_buzz(50) == 0
assert fizz_buzz(78) == 2
assert fizz_buzz(79) == 3
‘‘‘
Tests failed:
[AI-generated Feedback]:
1. **Generalization Check**: The solution uses a loop to iterate through all integers less than ‘n‘ and
checks divisibility by 11 or 13,
which is a general approach. It then counts occurrences of the digit ′7′ in these numbers, which is
correctly implemented using
‘str(i).count(′7′)‘.
2. **Boundary Check**: The loop iterates from 0 to ‘n−1‘, which correctly covers all integers less
than ‘n‘. There are no apparent
one-by-one errors in the loop or conditions.
3. **Edge Case Check**: The solution should handle edge cases such as ‘n = 0‘ or ‘n = 1‘. However, it
does not handle negative
inputs which could lead to incorrect results.
4. **Major Efficiency Check**: The solution runs in O(n) time complexity, which is eeicient given the
problem constraints. The space
complexity is O(1) as it uses a constant amount of extra space.
<assistant>:
Here is the improved implementation of the ‘fizz_buzz‘ function, incorporating the suggested
changes:
‘‘‘python
def fizz_buzz(n: int) −> int:
″″″Return the number of times the digit 7 appears in integers less than n which are divisible by 11
or 13.
>>> fizz_buzz(50)
0
>>> fizz_buzz(78)
2
>>> fizz_buzz(79)
3
>>> fizz_buzz(10)
0
>>> fizz_buzz(−5)
0
″″″
if n <= 0:
return 0
count = 0
for i in range(11, n):
if i % 11 == 0 or i % 13 == 0:
count += str(i).count(′7′)
return count

In one embodiment, the critic agent 212 may interact with thinker agent 202, solver agent 204, debugger agent 206 to evaluate a generated code program, based on which to decide a next-step action. For example, a code tree structure (similar to 300 in FIG. 3) may be built for each problem 302, where the tree root represents a problem specification (D, {(iⱼ, oⱼ)}) and every subsequent tree node represents a generated code solution Ŵᵢ. Each node has relevant attributes including its collective code feedback Fᵢ and its corresponding strategy and reflections: Sᵢ and Rᵢ. Typically, adding a tree node is a two-step process: 1) generate a code solution from the corresponding strategy (Eq. 2 or Eq. 6), 2) evaluate the generated solution Ŵᵢ and obtain environmental feedback (Eq. 4). Unlike previous tree-structure search methods, the entire tree is not constructed in the beginning. Instead, we introduce the critic agent 212 dynamically expands the tree based on potential strategies and guide the expansion and spanning of the tree, taking actions based on its evaluation of the current node. To effectively perform exploration within the tree structure, both environmental execution-based feedback as well as AI-generated feedback (generated by a “Critic” LLM agent) are formulated as feedback.

For example, the critic agent 212 may perform node scoring and evaluation 216. For a given solution and corresponding Fₑₓₑ, the critic agent 212 performs an evaluation, measuring how promising it is through equation 4, which results in F_{cri}. The critic agent 212 then separately evaluates how well: 1) the execution outputs of test cases match expected outputs on visible test cases; and 2) the solution robustly implements its corresponding strategy towards problem-solving. For one program Ŵᵢ and its corresponding feedback Fᵢ, the critic agent 212 may evaluate whether the current solution is worth refining, or it should not be explored, making decision between refinement and abort. The critic score is calculated following the equation:

$$Score ( {W}_{i} ) = Score ( {F}_{exe , i} ) + Score ( {F}_{cri , i} ) \qquad ( 7 )$$

For another example, the critic agent 212 may perform solution verification. For one Ŵᵢ that passes all visible test cases, it might potentially over-fit the visible test cases and could fail hidden test cases. Hence, the critic agent θ_{C} may verify if this solution is robust and generalizable to unseen test cases.

For another example, the critic agent 212 may then perform decision-making for the next action: starting from the initial Sᵢ, Wᵢ, Fᵢ, the critic agent 212 guides the search for a correct solution. At each node, it has an action space of three actions: Refine: Continue exploring from the current node by generating multiple reflections for this node; Abort: Prune this node due to its low evaluation score, and retrace the exploration to its sibling nodes; and Accept: Accept the current node as the final solution and terminate the search early.

An example prompt for the critic agent 212 to verify a code program generated by the solver agent 204 and then decide whether to reject or to refine this code program, may take a form similar to:

<system>:
The user will provide a programming task along with a solution that passes all visible test cases.
Your task is to further review the
solution before it is judged against hidden test cases. Determine whether the solution is robust and
general enough to pass unseen,
valid test cases. Guideline:
1. Generalization Check: Verify that the solution uses general methods, avoiding hardcoding specific
values or cases unless
explicitly required. Confirm that the approach logically extends to unseen cases without special
assumptions.
2. Boundary Check: Ensure all boundaries are correctly handled, including list indexing, loop start
and end points, if-else
conditions, and recursion exits. Look for potential oe-by-one errors or boundary misses that could
cause functional errors.
3. Edge Case Check: Confirm that the solution correctly handles valid edge/corner cases, such as
zero, negative, empty, boundary
values, or other special problem-specific situations. Note: All unseen test cases are guaranteed to
follow stated data types,
formats, conditions, and other constraints in the problem, no need to handle unallowed inputs. Do
NOT apply redundant handling
for cases that the current solution inherently manages, such as empty lists in sorting algorithms
(‘sorted([ ]) → [ ]‘), unless they
explicitly fail (e.g., ‘max([ ]) → error‘).
4. Major Eeiciency Check: Check if the solution is within polynomial time/space complexity. If not,
fail this check.
**Response Format**:
Firstly, within several sentences, follow the guideline and briefly analyse.
On a new line, respond with “True” if the solution is ACCEPTABLE as-is, or “False” if NECESSARY
modifications are required to
handle unseen valid test cases.
<user>:
[Problem description]:
‘‘‘
def fizz_buzz(n: int):
″″″Return the number of times the digit 7 appears in integers less than n which are divisible by 11
or 13.
>>> fizz_buzz(50)
0
>>> fizz_buzz(78)
2
>>> fizz_buzz(79)
3
″″″
‘‘‘
[Implementation]:
‘‘‘
def fizz_buzz(n: int):
″″″Return the number of times the digit 7 appears in integers less than n which are divisible by 11
or 13.
>>> fizz_buzz(50)
0
>>> fizz_buzz(78)
2
>>> fizz_buzz(79)
3
″″″
# Start by understanding the problem requirements and constraints, focusing on the need to count
occurrences of
the digit ′7′ in specific integers.
count = 0
for i in range(n):
if i % 11 == 0 or i % 13 == 0:
count += str(i).count(′7′)
return count
‘‘‘
[Execution Feedback on Visible Test Cases]:
Tested passed:
assert fizz_buzz(50) == 0
assert fizz_buzz(78) == 2
assert fizz_buzz(79) == 3
Tests failed:
<assistant>:
1. **Generalization Check**: The solution uses a loop to iterate through all integers less than ‘n‘ and
checks divisibility by 11 or 13,
which is a general approach. It then counts occurrences of the digit ′7′ in these numbers, which is
correctly implemented using
‘str(i).count(′7′)‘.
2. **Boundary Check**: The loop iterates from 0 to ‘n−1‘, which correctly covers all integers less
than ‘n‘. There are no apparent
oe-by-one errors in the loop or conditions.
3. **Edge Case Check**: The solution should handle edge cases such as ‘n = 0‘ or ‘n = 1‘. However, it
does not handle negative
inputs which could lead to incorrect results.
4. **Major Eeiciency Check**: The solution runs in O(n) time complexity, which is eeicient given the
problem constraints. The space
complexity is O(1) as it uses a constant amount of extra space.
False

Another example prompt for the critic agent 212 to evaluate an execution output of a code program may take a form similar to:

<system>:
Your task is to evaluate the execution outputs of a code implementation. The statement and code is
given by the user, and the
output/expected output on a set of test cases. You should analyze the expected outputs and
execution outputs. From a 0 to 5 range,
give a score on how good the execution outputs are matching the expected ones (higher score
means a better match). Standards
are below:
0: Errors or time out when executing.
1: No pattern found when comparing pairs of <output, expected_output>, errors are hard to
interpret.
2: Results abnormal for a part of cases(e.g., cannot handle negative elements; only half of it sorted).
3: Mismatches have clear patterns to interpret the error. For examples, all elements ojset by 1; all
elements + 1; reverse all
elements etc.,
4: Lack consideration of edge condition/corner cases(e.g., error only when elements are equal),
otherwise correct
5: Results exactly matched.
-----------------------------------
Your answer should be formatted as below:
In the first line, give your brief comparison.
In the second line, give A SINGLE INTEGER NUMBER as your final score(0 to 5)
<user>:
[problem]
[solution]
[execution results on visible test cases]

Another example prompt for the critic agent 212 to score a strategy may take a form similar to:

<system>: Your task is to evaluate a strategy and corresponding implementation for solving a
programming problem. You should
score from 1 to 5(higher means better) on how well do the solution implement the strategy and
solve the task?
-----------------------------------
Your answer should be formatted as below:
In the first line, give your brief analysis.
In the second line, give A SINGLE INTEGER NUMBER as your final score(0 to 5)
<user>:
[problem]
[solution]
[execution results on visible test cases]

FIG. 3 is a simplified diagram illustrating aspects of flexibly navigating a code tree structure for code generation employing the multiple LLM agents described in FIG. 2, according to embodiments described. In one embodiment, the code tree structure 300 may comprise a hierarchical data structure is constructed and navigated to facilitate code generation in response to a given problem specification 302. The code tree structure 300 is initialized with a root node representing the problem specification 302, which may be derived from a natural language query or other structured input (e.g., similar to 106 in FIG. 1). Each non-root node in the tree 300 may correspond to a code candidate. Each node may also encapsulate metadata including the applied generation strategy, environmental feedback (e.g., feedback by executing the respective code candidate), and performance evaluation results (e.g., evaluation scores, or AI-generated feedback by the critic agent 212).

In one embodiment, the construction and navigation of the code tree structure 300 proceeds incrementally. From the root node of problem specification 302, the thinker agent 202 may determine the number of strategies for the problem specification 302 and generate strategies 303, 305, 307, 309 and 311. A new node is thus added, for example, by the solver agent 204 to generate an initial code program 313 based on the specific code synthesis strategy 303 (e.g., as defined in Eq. 2 or Eq. 6). Different initial code programs 315, 317, 319 may not be generated in parallel, but each generation path following each strategy 303, 305, 307, 309, 311 may be explored downward one after another. For example, initial code program 315 based on strategy 305 may be generated only when the path down the strategy 303 is aborted. Thus, tree growth supports heterogeneous branching, where sibling nodes represent alternative strategies from the same parent context, and child nodes represent refinements or successive elaborations of a given code path. In this way, computational complexity may be reduced, as the code tree structure 300 is navigated with only necessary computational steps.

In one embodiment, continuing on from the node comprising initial code 313, the initial code program 313 may be evaluated to collect feedback from an execution environment (e.g., as specified by Eq. 4), and/or by the critic agent 212. The critic agent 212 performs evaluation tasks of the initial code program 313 to determine the appropriateness of further expansion. In particular, the critic agent 212 may generate a node score for a node associated with a candidate code program (e.g., initial code 313), which involves executing the initial code 313 on a suite of visible test cases and computing a fidelity score that reflects both output correctness and adherence to the intended generation strategy 303. Additionally, the critic agent 212 may determine whether the candidate code (e.g., initial code 313) is robust and generalizable. For example, a solution that passes all visible test cases may still overfit to these specific cases and fail to generalize to hidden test cases.

As described in relation to FIG. 2, at each decision point, the critic agent 212 may select an action from a predefined action space comprising three operations, refine, abort or accept. For example, as shown in FIG. 3, at reflection 323, the critic agent 212 may decide to refine the initial code program 313, which lead to the thinker agent 202 to generate error reflection 323 based on the evaluation results and subsequently the debugger agent 206 to generate a refined code 325 based on the error reflection 323. Similarly, the refined code 325 may be evaluated to collect feedback from an execution environment (e.g., as specified by Eq. 4), and/or by the critic agent 212 in a similar manner as that of the initial code 313. And the critic agent 212 may then again decide whether to refine, abort or accept—here, the critic agent 212 may decide to abort based on the refined code 325.

In one embodiment, at the abortion after refined code 325, the code tree structure 3000 may grow through heterogeneous branching, e.g., to expand to sibling node representing an alternative path from the parent node. For example, the critic agent 212 may decide to refine the initial code 313 again, further based on feedback from the abortion of refined code 325. In this path, the thinker agent 202 may again be invoked to generate error reflection 327 based on the abortion of the refined code 315, and evaluation results of the initial code 313. The debugger agent 206 may further generate a refined code 329 based on the error reflections 327. Thus, in a similar manner, the critic agent 212 may guide the expansion of the tree structure 300 until another abortion decision is made, e.g., at refined code 331.

In one embodiment, the critic agent 212 may further decide whether to go back to the initial code 313 again, or to further go back to restart from another strategy 305. For example, the critic agent 212 may decide the number of children for each node, e.g., node of the initial code 313. As shown in FIG. 3, the critic agent 212 may decide after two unsuccessful attempts (both refined codes 325 and 331 are aborted), the navigation process may proceed to the next strategy 305.

In one embodiment, the critic agent 212 may continue guiding the expansion of the code tree structure 300 to generate and then abort the initial code 315; switch to the next strategy 307 and thus generate a new initial code 317 but abort it after one round of refinement; switch to the next strategy 309 and thus generate a new initial code 319, further refine the code until the critic agent 212 decides that a refined code 343 down this branch is accepted as the final code output. At this point, the navigation process may terminate and no further expand to the strategy 311.

Therefore, as described in relation to FIGS. 2-3, throughout the expansion of the tree 300, the task specific agents (e.g., thinker agent 202, solver agent 204 and debugger agent 206) collaborate with Critic Agent 212, utilizing its feedback, and follow its guidance to perform exploration. The flexibility of the tree expansion and search is determined by LLM agents' decision making, e.g. determining the number of strategies and deciding the search path. During inference time, practically, the number of exploration steps may be limited to avoid large computation overhead. Whenever a termination signal 224 (i.e. to accept a code solution) is found or the maximum number of exploration steps is reached, a code candidate is selected based on its evaluation score Score (Ŵᵢ), e.g., the highest score.

### Computer and Network Environment

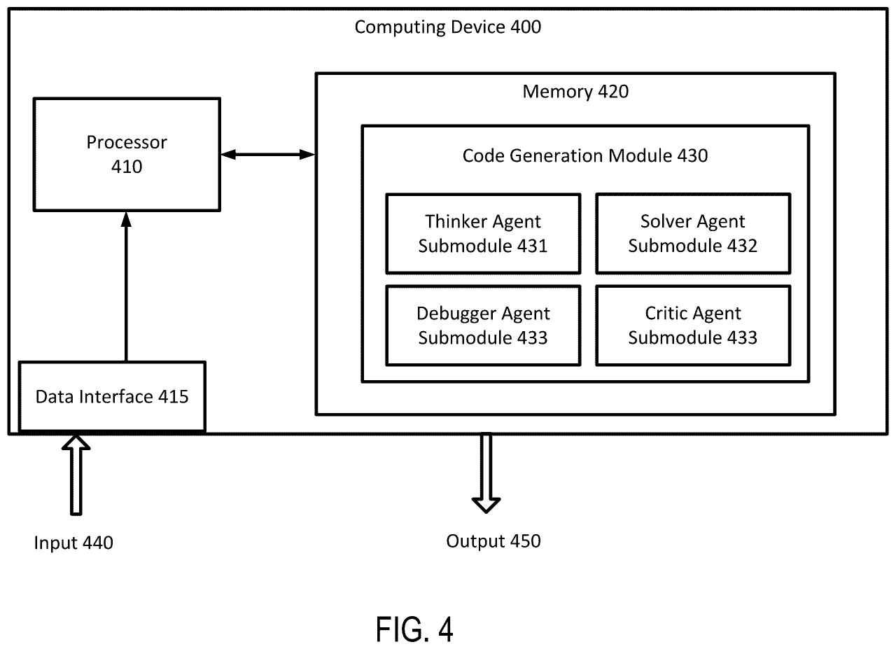

FIG. 4 is a simplified diagram illustrating a computing device implementing the code generation framework described in FIGS. 1-3, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 4B.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for code generation module 430 that may be used to implement and/or emulate the systems and models, and/or to implement any of the methods described further herein. code generation module 430 may receive input 440 such as an input training data (e.g., a problem description) via the data interface 415 and generate an output 450 which may be a. code program.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a problem description, from a user via the user interface.

In some embodiments, the code generation module 430 is configured to generate a code program. The code generation module 430 (e.g., similar to AI agent 110 in FIG. 1) may further include a Thinker agent submodule 431 (e.g., similar to 202 in FIG. 2), a Solver agent submodule 432 (e.g., similar to 204 in FIG. 2), a Debugger agent submodule 433 (e.g., similar to 206 in FIG. 2) and a Critic agent submodule 434 (e.g., similar to 212 in FIG. 2). Additional descriptions of agents 431-434 may be described in relation to FIG. 2.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating the neural network structure implementing the code generation module 430 described in FIG. 4, according to some embodiments. In some embodiments, the code generation module 430 and/or one or more of its submodules 431-434 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as a problem description. The number of nodes (neurons) in the input layer 441 may be determined by the dimensionality of the input data (e.g., the length of a vector of problem description). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4, the code generation module 430 receives an input 440 of problem description and transforms the input into an output 450 of a code program. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the code generation module 430 and/or one or more of its submodules 431-434 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a Transformer-based LLM, and/or the like.

In one embodiment, the code generation module 430 and its submodules 431-434 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the code generation module 430 and its submodules 431-434 may be implemented by hardware, software and/or a combination thereof. For example, the code generation module 430 and its submodules 431-434 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the code generation module 430 and its submodules 431-434 and/or any other neural network models onto hardware platform 460, the neural network based modules 430 and its submodules 431-434 may be optimized for deployment by converting it to a suitable format, such as ONNX or TensorRT, to improve performance and compatibility. Next, depending on the size and workload requirements for modules 430 and its submodules 431-434, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the code generation module 430 and its submodules 431-434 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the code generation module 430 and its submodules 431-434 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the code generation module 430 and its submodules 431-434 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the code generation module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based code generation module 430 and one or more of its submodules 431-434 may be trained by iteratively updating the underlying parameters (e.g., weights 451, 452, etc., bias parameters and/or coefficients in the activation functions 461, 462 associated with neurons) of the neural network based on the loss. For example, during forward propagation, the training data such as problem description and code program pairs are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding code program) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based code generation module 430 and one or more of its submodules 431-434 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

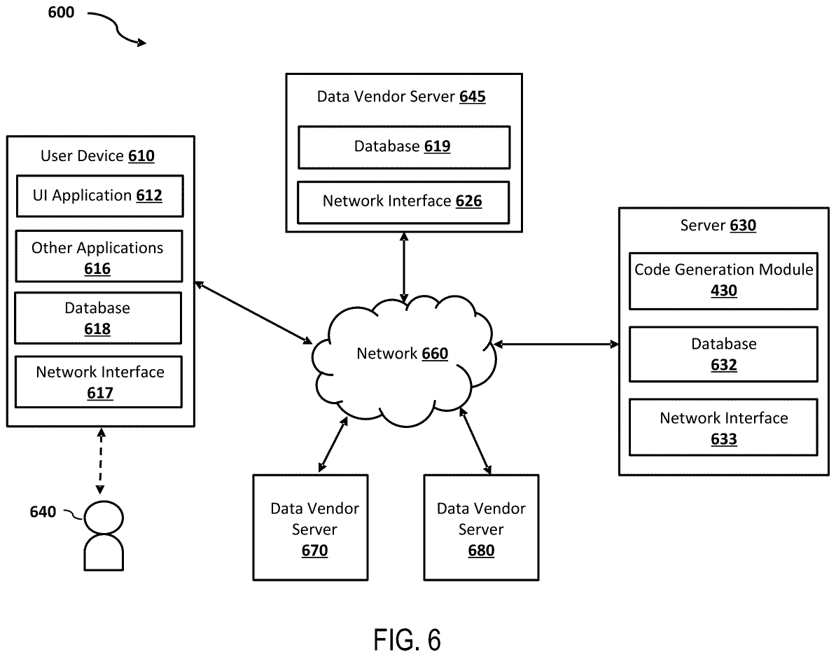

In one embodiment, code generation module 430 and its submodules 431-434 may be housed at a centralized server (e.g., computing device 400) or one or more distributed servers. For example, one or more of code generation module 430 and its submodules 431-434 may be housed at external server(s). The different modules may be communicatively coupled by building one or more connections through application programming interfaces (APIs) for each respective module. Additional network environment for the distributed servers hosting different modules and/or submodules may be discussed in FIG. 6.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating a code program to resolve a network debugging issue.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in automatic code generation.

FIG. 6 is a simplified block diagram of a networked system 600 suitable for implementing the code generation framework described in FIGS. 1-5 and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a code program from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the code generation module 430 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which code generation module 430 may generate a response via the process described in FIGS. 1-5. The code generation module 430 may thus cause a display of code program at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view the code program or the generated result.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including problem descriptions and/or code programs to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the code generation module 430 and its submodules described in FIG. 4A. In some implementations, code generation module 430 may receive data from database 619 at the data vendor server 645 via the network 660 to generate a code program. The generated code programs may also be sent to the user device 610 for review by the user 640 via the network 660.

In one embodiment, an AI agent implementing the code generation module 430 and its submodules described in FIG. 4 may be built based on an LLM as described in FIG. 4B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the code generation module 430 and its submodules described in FIG. 4 may be implemented as a cloud-based AI agent which may be accessed by user device 610 via a chatbot application, a web application, customer support or SaaS applications. In another implementation, a client-side AI agent component may be delivered from the server 630 to user device 610 for local installation such that the client-side AI agent may be installed and runs directly on the user's device. Such local AI agent on the user device 610 may be available offline to adapt to privacy-sensitive applications. In another implementation, the AI agent implementing the code generation module 430 and its submodules described in FIG. 4 may adopt a hybrid cloud and client-based structure to balance computing speed, cost and privacy. For example, a local AI agent may handle basic AI queries locally, but complex queries may be sent to server 630 to process.

The database 632 may be stored in a transitory and/or non-transitory memory of the server 630. In one implementation, the database 632 may store data obtained from the data vendor server 645. In one implementation, the database 632 may store parameters of the code generation module 430. In one implementation, the database 632 may store previously generated code programs, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flows

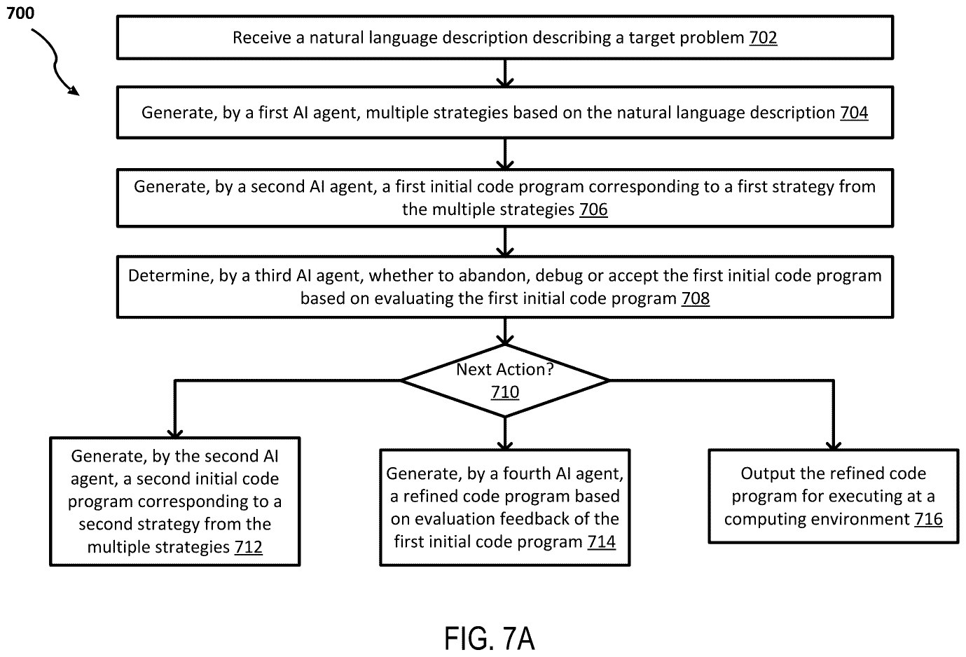

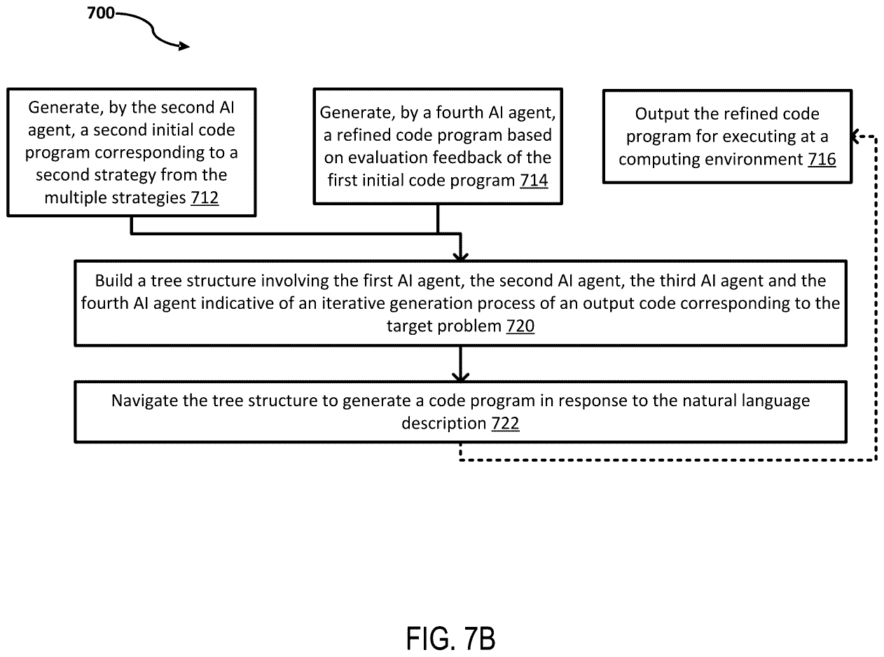

FIGS. 7A-7B provide an example logic flow diagram illustrating a method of AI agentic code generation based on a natural language description based on the framework shown in FIGS. 1-6, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the code generation module 730 (e.g., FIGS. 4 and 6) that generates and/or executes a code program in response to a problem specification.

In some embodiments, method 700 is performed by a system such as computing device 400, user device 610, server 630, or another device or combination of devices. Inputs (e.g., a problem specification) may be received via a data interface such as data interface 415, network interface 617, network interface 633, or via a data interface that is integrated with a device. For example UI Application 612 may receive user inputs via a text input interface (e.g., keyboard), audio input (e.g., microphone), video interface (e.g., camera), or other interface for receiving user inputs (e.g., a mouse or touch display).

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, the AI agent may receive a natural language description (e.g., 106 in FIG. 1, 302 in FIG. 3) describing a target problem, e.g., via data interface 415 in FIG. 4, network interface 633 in FIG. 6.

At step 704, in response to the natural language description describing a target problem, a first AI agent (e.g., thinker agent 202 in FIG. 2) may generate multiple strategies (e.g., 303, 305, 307, 309 and 311 in FIG. 3) based on the natural language description (e.g., 302 in FIG. 3). For example, the first AI agent may determine how many strategies to generate based on a complexity level of the natural language description.

At step 706, a second AI agent (e.g., solver agent 204 in FIG. 2) may generate a first initial code program (e.g., 313 in FIG. 3) corresponding to a first strategy (e.g., 303 in FIG. 3) from the multiple strategies.

At step 708, a third AI agent (e.g., critic agent 212 in FIG. 2) may determine the next action 410, e.g., whether to abandon, debug or accept the first initial code program based on evaluating the first initial code program. For example, the third AI agent may evaluatw the first initial code program by at least one of: executing the first initial code program at a coding environment; generating, by the third AI agent, AI-based execution feedback for the first initial code program; and generating collective code feedback based on an environmental feedback from execution and the AI-based execution feedback.

In response to the third AI agent determining to abandon the first initial code program, method 700 proceeds to step 712, at which the second AI agent (e.g., solver agent 204) generates a second initial code program (e.g., 315 in FIG. 3) corresponding to a second strategy (e.g., 305) from the multiple strategies. For example, the second initial code program is generated based at least in part on the collective code feedback.

In response to the third AI agent determining to debugging the first initial code program, method 700 proceeds to step 714, at which a fourth AI agent (e.g., debugger agent 206 in FIG. 2) generates a refined code program (e.g., 323 or 327 in FIG. 3) based on evaluation feedback of the first initial code program.

In response to the third AI agent determining to accepting the first initial code program, method 700 proceeds to step 716, at which to output the refined code program for executing at a computing environment.

Iteratively, steps 712 and 714 may both proceed to step 720, at which a tree structure (e.g., 300 in FIG. 3) involving the first AI agent, the second AI agent, the third AI agent and the fourth AI agent indicative of an iterative generation process of an output code corresponding to the target problem. For example, the tree structure comprises a root node (e.g., 302 in FIG. 3) representing the target problem, a first level of child nodes representing the multiple strategies and corresponding initial code programs, and a second level of child nodes including at least one second-level child node representing the refined code program.

At step 722, method 700 may navigate the tree structure to generate a code program in response to the natural language description, which may repeat steps 704-716 at different nodes of the tree and eventually arrive at step 716. For example, the tree structure may be navigated guided by the third AI agent. The third AI agent may generate an evaluation score for at least one child node based on the collective code feedback, and selectively performing, based on the evaluation score, one of: navigating to a next-level child node from the at least one child node, aborting navigation from the at least one child node and retracing to a sibling node at a same level with the at least one child node; or accepting the at least one child node as the output code. The tree structure may thus be adaptively expanded based at least in part on the evaluation score generated for each child node in the tree structure.

In one embodiment, one or more of the first AI agent, the second AI agent, the third AI agent and the fourth AI agent are built on a shared pretrained language model using different prompts. Once the tree structure is built, it may be stored and reused to generate the new code program in response to the new natural language description. The tree structure may be dynamically updated while generating the new code program.

In some embodiments, method 700 is applicable in a variety of applications. For example, problem specification 302 may comprise real-time problems from autonomous driving, cybersecurity and/or other applications. For example, in autonomous systems, precision and reliability are critical-improved code generation through method 700 may provide better quality code programs for sensor fusion, decision-making algorithms, and real-time responsiveness, ultimately improving safety and performance. In cybersecurity, AI-assisted coding through method 700 can support the development of advanced detection systems that identify and adapt to malicious attacks more effectively by automating threat pattern recognition and response logic. Once the malicious attacks are identified in real-time, the generated code program may further be executed to block traffic, e.g., at a network gateway, from the identified origin of the malicious traffic.

### Example Results

Example data experiments have been conducted to evaluate quality of generated code programs through the flexible code tree described in FIGS. 1-6. The evaluation metric used is pass@1, where only one code candidate is selected and submitted for final evaluation using hidden test cases. A generation budget of 20 samples per coding task is applied uniformly across all methods to ensure a fair comparison. In ablation experiments that exclude the Critic Agent, a solution that passes all visible test cases is selected as the final submission.

Experiments are conducted across two categories of code generation tasks: (1) Function implementation tasks, which require completing a single function with a specified signature, using benchmarks such as HumanEval (Chen et al., Teaching large language models to self-debug. arXiv preprint arXiv: 2304.05128, 2022), MBPP (Liu et al., Is your code generated by chat-GPT really correct? rigorous evaluation of large language models for code generation, 37th Conference on Neural Information Processing Systems, 2023), and their EvalPlus variants (HumanEval+ and MBPP+); and (2) Program implementation tasks, which involve solving algorithmic problems, using CodeContests (Li et al., Competition-level code generation with alphacode. arXiv preprint arXiv: 2203.07814, 2022) and APPS (Hendrycks et al., Measuring coding challenge competence with apps, proceedings of NeurIPS, 2021) benchmarks. The test set sizes are 164 for HumanEval (+), 378 for MBPP (+), and 165 for CodeContests. For APPS, 150 samples are randomly selected, with an even distribution across difficulty levels.

The following baselines are included: Direct, which prompts the model to generate code from the input problem; CoT (Wei et al., Chain-of-thought prompting elicits reasoning in large language models. Advances in Neural Information Processing Systems, 35:24824-24837, 2022), which introduces chain-of-thought reasoning prior to generating the solution; Reflexion (Shinn et al., Reflexion: Language agents with verbal reinforcement learning. Preprint, arXiv: 2303.11366, 2023), which leverages execution feedback for self-reflection and iterative refinement; MapCoder (Islam et al., Mapcoder: Multi-agent code generation for competitive problem solving, arXiv preprint arXiv: 2405.11403, 2024), which employs a collaborative agent system to plan, solve, test, and refine code, configured with four plans, five debugging rounds, and a generation budget of 20; and Resample, which repeatedly resamples and filters solutions based on visible test cases.

LLM 120 may be chosen from the GPT and Llama 3.1 family. Specifically we use GPT-40-mini, GPT-40 and Llama-3.1-8B.

Table 1 presents a comparison of the code tree structure 300 (referred to as “CodeTree”) with other baseline methods. Reflexion and Resampling are strong performers on the HumanEval and MBPP datasets under an equal solution generation budget, showing performance levels comparable to CodeTree-BFS and CodeTree-DFS. CodeTree with the Critic Agent achieves higher performance than all other baselines on 4 out of 5 benchmarks when using GPT-40-mini and GPT-40. For example, on the CodeContests benchmark, which includes competition-level coding tasks, CodeTree reaches a pass@1 score of 43.0%, representing a 22.4% improvement over the Resampling baseline.

TABLE 1
Experimental results by pass@1 on HumanEval, MBPP, EvalPlus, and CodeContests

| Model | Method | HumanEval | HumanE+ | MBPP | MBPP+ | Codecontests | Avg. |
|---|---|---|---|---|---|---|---|
| GPT-4o-mini | Direct | 86.6% | 78.7% | 87.8% | 73.3% | 10.3% | 67.3% |
| | CoT | 84.8% | 78.0% | 89.2% | 74.3% | 12.7% | 67.8% |
| | Reflexion | 92.1% | 83.5% | 96.6% | 78.6% | 21.8% | 74.5% |
| | MapCoder | 91.5% | 78.0% | 90.0% | — | — | — |
| | Resample | 89.0% | 80.5% | 94.3% | 76.8% | 18.2% | 71.8% |
| | CodeTree-BFS | 93.3% | 82.1% | 91.5% | 72.3% | 20.6% | 72.0% |
| | CodeTree-DFS | 92.7% | 81.1% | 87.6% | 71.4% | 20.6% | 70.7% |
| | Strategy List | 90.2% | 80.5% | 90.5% | 69.6% | 22.4% | 70.6% |
| | CodeTree | 94.5% | 84.8% | 96.8% | 77.0% | 26.4% | 75.9% |
| GPT-4o | Direct | 88.4% | 81.7% | 92.3% | 75.9% | 20.6% | 71.8% |
| | CoT | 92.1% | 84.1% | 93.7% | 77.2% | 24.8% | 74.4% |
| | Reflexion | 94.5% | 84.8% | 97.9% | 79.6% | 41.8% | 79.7% |
| | MapCoder | 92.7% | 81.7% | 90.9% | — | — | — |
| | Resample | 93.9% | 84.8% | 96.2% | 77.0% | 32.7% | 76.9% |
| | CodeTree-BFS | 94.5% | 84.1% | 93.9% | 70.7% | 35.8% | 75.8% |
| | CodeTree-DFS | 95.1% | 83.5% | 91.5% | 76.2% | 36.4% | 76.5% |
| | Strategy List | 95.1% | 82.3% | 92.6% | 73.3% | 36.4% | 75.9% |
| | CodeTree | 94.5% | 86.0% | 98.7% | 80.7% | 43.0% | 80.6% |
| Llama-3.1-8B | Direct | 63.4% | 54.3% | 73.4% | 63.8% | 6.1% | 52.2% |
| | CoT | 65.9% | 56.1% | 74.6% | 65.3% | 4.2% | 53.2% |
| | Reflexion | 79.9% | 69.5% | 90.2% | 72.0% | 13.5% | 65.0% |
| | Resample | 82.3% | 71.3% | 91.0% | 73.8% | 15.2% | 66.7% |
| | CodeTree-BFS | 80.5% | 68.3% | 91.0% | 69.3% | 15.8% | 65.0% |
| | CodeTree-DFS | 80.5% | 68.9% | 89.7% | 70.4% | 15.2% | 64.9% |
| | Strategy List | 82.3% | 70.1% | 91.0% | 72.5% | 13.9% | 66.0% |
| | CodeTree | 82.3% | 72.0% | 90.5% | 73.3% | 12.1% | 66.0% |

CodeTree-BFS consistently outperforms CodeTree-DFS, indicating that exploring diverse solution paths is generally more effective than refining a single solution. On the Llama-3.1-8B model, Resampling yields the best results across 4 benchmarks. This outcome suggests that smaller language models may not perform well in multi-agent frameworks like CodeTree, which rely on the model's ability to follow distinct task-specific roles and instructions with a high degree of accuracy.

To investigate the performance differences between CodeTree-BFS and CodeTree-DFS, additional experiments were conducted without the Critic Agent. Results on HumanEval/HumanEval+using GPT-40-mini and on CodeContests using GPT-40 are shown in Table 3. When comparing DFS and BFS strategies with depth d=3d=3d=3 and width w=3w=3w=3, increasing the search width in BFS (i.e., exploring more diverse strategies with w>3w>3w>3) and limiting debugging to one iteration (d=2d=2d=2) led to improved pass@1 performance. In contrast, for DFS, increasing the depth of refinement (d>3d>3d>3) did not yield significant gains.

TABLE 2
Pass@1 results of CodeTree-BFS/DFS on HumanEval,
HumanEval+ and Code Contest

| Model | GPT-4o-mini | | GPT-4o |
|---|---|---|---|
| Benchmark | HumanEval | HumanEval+ | CodeContests |

CodeTree-BFS

| | | | |
|---|---|---|---|
| d = 3, w = 3 | 93.3% | 82.3% | 36.4% |
| d = 2, w = 4 | 95.1% | 84.1% | 37.6% |
| d = 2, w = 5 | 94.5% | 83.4% | 39.4% |

CodeTree-DFS

| | | | |
|---|---|---|---|
| d = 3, w = 3 | 92.7% | 81.1% | 36.4% |
| d = 4, w = 2 | 92.1% | 81.1% | 37.0% |
| d = 5, w = 2 | 92.1% | 81.7% | 36.4% |

For specific benchmarks, a width of w=4w=4w=4 produced better results on HumanEval, while w=5w=5w=5 was more effective for CodeContests, suggesting that more complex tasks benefit from a broader exploration of solution strategies. These findings are consistent with the design of CodeTree, in which the Critic Agent dynamically adjusts the number of child nodes to explore based on contextual information.

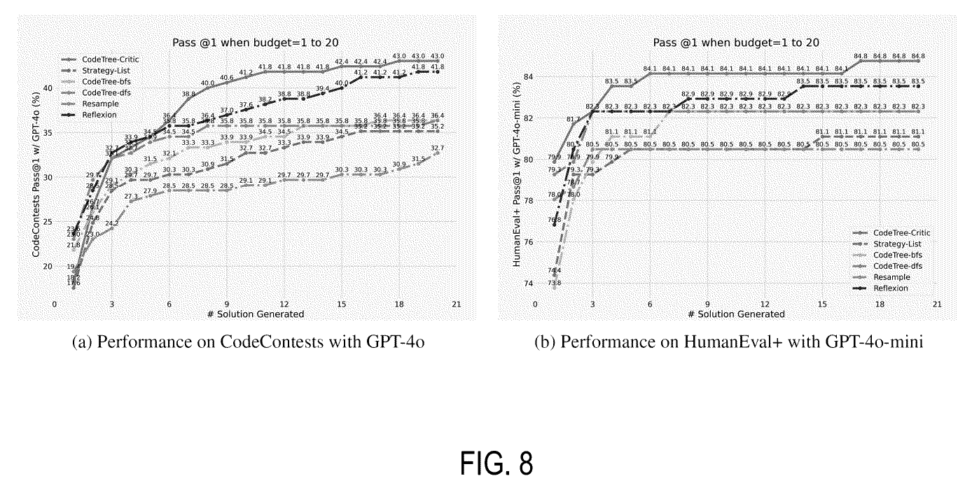

CodeTree was evaluated on coding problems with varying levels of difficulty using a test set of 150 problems, sampled evenly from the “introductory,” “interview,” and “competition” categories in the APPS benchmark. The results are presented in FIG. 8.

Performance results indicate that CodeTree is more effective on simpler tasks-particularly at the introductory level for GPT-40-mini, and at both the introductory and interview levels for GPT-40. However, performance declines on competition-level problems, suggesting challenges in solving highly complex tasks. While CodeTree enhances search efficiency toward correct solutions, the fixed generation budget of 20 samples may be insufficient for addressing the complexity of more difficult problems.

To assess the efficiency of the CodeTree tree search strategy compared to other methods, experiments were conducted using varying solution generation budgets, ranging from 1 to 20 samples. FIG. 8 presents pass@1 results relative to the number of sampled solutions: (a) shows results on CodeContests using GPT-40, and (b) on HumanEval+ using GPT-40-mini. In both settings, CodeTree demonstrates higher performance than other approaches, including when the generation budget is small (e.g., fewer than 9 samples). On CodeContests, although CodeTree initially shows lower performance with fewer than 5 samples, its performance improves notably as the search progresses, indicating potential for continued gains with larger budgets.

To further evaluate efficiency, experiments were also conducted with a larger generation budget of 30 samples, comparing CodeTree to OpenAI's o1-preview model in terms of cost and token usage (Table 3). Under this setup, CodeTree is able to reduce unnecessary exploration on simpler tasks while thoroughly exploring strategies for more complex problems. Results show that CodeTree surpasses o1-preview in performance while using fewer tokens and incurring lower cost, highlighting its efficiency in solution search for programming tasks.

TABLE 3
Efficiency Comparison

| Model | MBPP+ | HumanEval+ | Codecontests |
|---|---|---|---|
| Resample | 77.0% (0.3k) | 84.8%(0.4k) | 41.2%(2.4k) |
| Reflexion | 79.6% (0.5k) | 85.4% (0.7k) | 46.1% (6.0k) |
| CodeTree | 82.8% (0.7k) | 89.6% (0.9k) | 49.1% (4.8k) |
| O1-preview | 80.2% (1.0k) | 89.0% (1.0k) | 46.6% (7.1k) |

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A computer-implemented method for artificial intelligence (AI) agentic code generation based on a natural language description, the method comprising:
in response to the natural language description describing a target problem, generating, by a first AI agent, multiple strategies based on the natural language description;
generating, by a second AI agent, a first initial code program corresponding to a first strategy from the multiple strategies;
determining, by a third AI agent, whether to abandon, debug or accept the first initial code program based on evaluating the first initial code program;
in response to the third AI agent determining to abandon the first initial code program, generating, by the second AI agent, a second initial code program corresponding to a second strategy from the multiple strategies;
in response to the third AI agent determining to debugging the first initial code program, generating, by a fourth AI agent, a refined code program based on evaluation feedback of the first initial code program;
in response to the third AI agent determining to accepting the first initial code program, outputting the refined code program for executing at a computing environment;
building a tree structure of the first AI agent, the second AI agent, the third AI agent and the fourth AI agent indicative of an iterative generation process of an output code corresponding to the target problem; and
navigating the tree structure to generate a code program in response to the natural language description.

2. The computer-implemented method of claim 1, wherein the generating, by the first AI agent, multiple strategies further comprises:
determining, by the first AI agent, how many strategies to generate based on a complexity level of the natural language description.

3. The computer-implemented method of claim 1, wherein the determining, by the third AI agent, whether to abandon, debug or accept the first initial code program further comprises:
evaluating the first initial code program by at least one of:
executing the first initial code program at a coding environment;
generating, by the third AI agent, AI-based execution feedback for the first initial code program; and
generating collective code feedback based on an environmental feedback from execution and the AI-based execution feedback.

4. The computer-implemented method of claim 1, wherein the generating, by the second AI agent, the second initial code program is based at least in part on the collective code feedback.

5. The computer-implemented method of claim 1, wherein the tree structure comprises a root node representing the target problem, a first level of child nodes representing the multiple strategies and corresponding initial code programs, and a second level of child nodes including at least one second-level child node representing the refined code program.

6. The computer-implemented method of claim 5, wherein the iterative generation process of the output code comprises:
navigating the tree structure guided by the third AI agent, including:
generating, by the third AI agent, an evaluation score for at least one child node based on the collective code feedback; and
selectively performing, based on the evaluation score, one of:
navigating to a next-level child node from the at least one child node;
aborting navigation from the at least one child node and retracing to a sibling node at a same level with the at least one child node; or
accepting the at least one child node as the output code.

7. The computer-implemented method of claim 1, further comprising:
adaptively expanding the tree structure based at least in part on the evaluation score generated for each child node in the tree structure.

8. The computer-implemented method of claim 1, wherein one or more of the first AI agent, the second AI agent, the third AI agent and the fourth AI agent are built on a shared pretrained language model using different prompts.

9. The computer-implemented method of claim 1, further comprising:
storing and reusing the tree structure to generate the new code program in response to the new natural language description.

10. The computer-implemented method of claim 1, further comprising:
dynamically updating the tree structure while generating the new code program.

11. A system for artificial intelligence (AI) agentic code generation based on a natural language description, the system comprising:
a communication interface receiving the natural language description;
a memory storing a plurality of processor-executable instructions; and
one or more processors executing the plurality of processor-executable instructions to operate:
a first AI agent to, in response to the natural language description describing a target problem, generate multiple strategies based on the natural language description,
a second AI agent to generate a first initial code program corresponding to a first strategy from the multiple strategies,
a third AI agent to determine whether to abandon, debug or accept the first initial code program based on evaluating the first initial code program,
wherein, in response to the third AI agent determining to abandon the first initial code program, the second AI agent is operatable to generate a second initial code program corresponding to a second strategy from the multiple strategies,
wherein, in response to the third AI agent determining to debug the first initial code program, a fourth AI agent is operable to generate a refined code program based on evaluation feedback of the first initial code program, and
wherein, in response to the third AI agent determining to accept the first initial code program, the system is operable to output the refined code program for execution at a computing environment;
to build a tree structure of the first AI agent, the second AI agent, the third AI agent, and the fourth AI agent indicative of an iterative generation process of an output code corresponding to the target problem; and
to navigate the tree structure to generate a code program in response to the natural language description.

12. The system of claim 11, wherein the first AI agent is further operated to determine how many strategies to generate based on a complexity level of the natural language description.

13. The system of claim 11, wherein the third AI agent is further operated to evaluate the first initial code program by at least one of:
executing the first initial code program at a coding environment;
generating AI-based execution feedback for the first initial code program; and
generating collective code feedback based on environmental feedback from execution and the AI-based execution feedback.

14. The system of claim 11, wherein the second AI agent is further operated to generate the second initial code program based at least in part on the collective code feedback.

15. The system of claim 11, wherein the tree structure comprises a root node representing the target problem, a first level of child nodes representing the multiple strategies and corresponding initial code programs, and a second level of child nodes including at least one second-level child node representing the refined code program.

16. The system of claim 15, wherein the iterative generation process of the output code comprises navigating the tree structure guided by the third AI agent, including:
generating, by the third AI agent, an evaluation score for at least one child node based on the collective code feedback; and
selectively performing, based on the evaluation score, one of:
navigating to a next-level child node from the at least one child node;
aborting navigation from the at least one child node and retracing to a sibling node at a same level with the at least one child node; or
accepting the at least one child node as the output code.

17. The system of claim 11, wherein the one or more processors further execute the plurality of processor-executable instructions to:
adaptively expand the tree structure based at least in part on the evaluation score generated for each child node in the tree structure.

18. The system of claim 11, wherein one or more of the first AI agent, the second AI agent, the third AI agent, and the fourth AI agent are built on a shared pretrained language model using different prompts.

19. The system of claim 11, wherein the one or more processors further execute the plurality of processor-executable instructions to:
store and reuse the tree structure to generate a new code program in response to a new natural language description.

20. The system of claim 11, wherein the one or more processors further execute the plurality of processor-executable instructions to:
dynamically update the tree structure while generating the new code program.
